(19) United States
(12) Patent Application Publication
(10) Pub. No.: US 2005/0125511 A1
(43) Pub. Date: Jun. 9, 2005

(54) Intelligent local proxy for transparent network access from multiple physical locations

(76) Inventor: Preston J. Hunt, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/731,643

(22) Filed: Dec. 8, 2003

(51) Int. Cl. G06F 15/177

(52) U.S. Cl. 709/220

(57) ABSTRACT

A method, machine readable medium, and system is disclosed. In one embodiment the method comprises connecting a device to a network, determining a unique identifier based on the network, obtaining network configuration settings that are associated with the unique network identifier, intercepting network traffic originating from an application located on the device, and rerouting the intercepted network traffic to a final correct location using the obtained network configuration settings.

### BACKGROUND OF THE INVENTION

Mobile computing devices, such as laptops, notebooks, and handhelds are becoming increasingly common and ubiquitous. People rely on these devices to connect to a local area network to have broadband access to the Internet wherever they travel. Most users of mobile computing devices must manually reconfigure their network settings whenever they move between networks. A person who can directly connect to the Internet at home might have to connect through a proxy server at work as well as a different proxy server at school. A laptop user who plans to regularly travel between these locations would be forced to manually reconfigure the device's network settings multiple times on a daily basis. Reconfiguring the network settings is not a trivial task, often requiring the user to manually configure each separate program that he wants to use. For example, while a user is at work he might be behind a firewall and require a special firewall traversal technique to establish an outbound Internet connection, such as through a SOCKS server or using hypertext transfer protocol (HTTP) tunneling. A number of applications on the user's laptop, such as Microsoft's Internet Explorer, RealNetworks' RealPlayer, or AOL's Instant Messenger, must be individually configured to use the special firewall traversal technique. When the user is at home, no special firewall traversal technique is required and the network settings for each application would subsequently need to be reconfigured to operate correctly. This obstacle is a major detraction from the adoption of home networking, and significantly reduces the ease-of-use of mobile computing platforms. Because many mobile users change their network location at least two times per day, this is a substantial annoyance and loss of productivity. The problem is further compounded because the cause of the problem is not immediately apparent and may require significant debugging time from the user.

An application such as Microsoft's Internet Explorer with the autoproxy feature can provide a limited solution to this problem. The autoproxy feature can automatically figure out how to traverse a corporate firewall or connect directly to the Internet when at home. But this is limited to a situation where a network administrator has a special Internet Explorer-specific autoproxy server on the corporate network. What Internet Explorer and other applications are lacking is a way to allow for automatic configuration to a network in any environment without the help of any external autoproxy information or IT departments. Additionally, there is no solution currently that employs a level of abstraction outside of the individual application. For example, Internet Explorer can configure itself with its specific autoproxy server, but it cannot configure other programs that need similar solutions.

Thus, there is a need for an effective method to allow for applications residing on a mobile device to auto-configure their network settings when the device connects to a given network. The method would not require any help external to the mobile device and would be abstracted to allow for use among all applications residing on the device that utilize network communication.

### BRIEF DESCRIPTION OF THE DRAWINGS

The present invention is illustrated by way of example and is not limited by the figures of the accompanying drawings, in which like references indicate similar elements, and in which:

FIG. 1 illustrates one embodiment of two sample environments in which the present invention operates.

FIG. 2 illustrates one embodiment of the present invention operating on a mobile computing device.

FIG. 3 illustrates the database in one embodiment of the invention.

FIG. 4 illustrates a step-by-step process for detecting a unique network identifier on a network in one embodiment of the present invention.

FIG. 5 illustrates a step-by-step process of a virtual network interface card implementation of one embodiment of the invention.

FIG. 6 illustrates a step-by-step process of a multiple unique local network port implementation of one embodiment of the invention.

FIG. 7 illustrates a step-by-step process of a virtual SOCKS server implementation of one embodiment of the invention

### DETAILED DESCRIPTION

A method for auto-configuring the network settings for each application residing on a mobile computing device when that device attaches to a given network is described. In some instances, well-known elements, protocols, and applications such as HTTP, SOCKS, POP3, Internet Explorer, and AOL Instant Messenger have not been discussed in special detail in order to avoid obscuring the present invention.

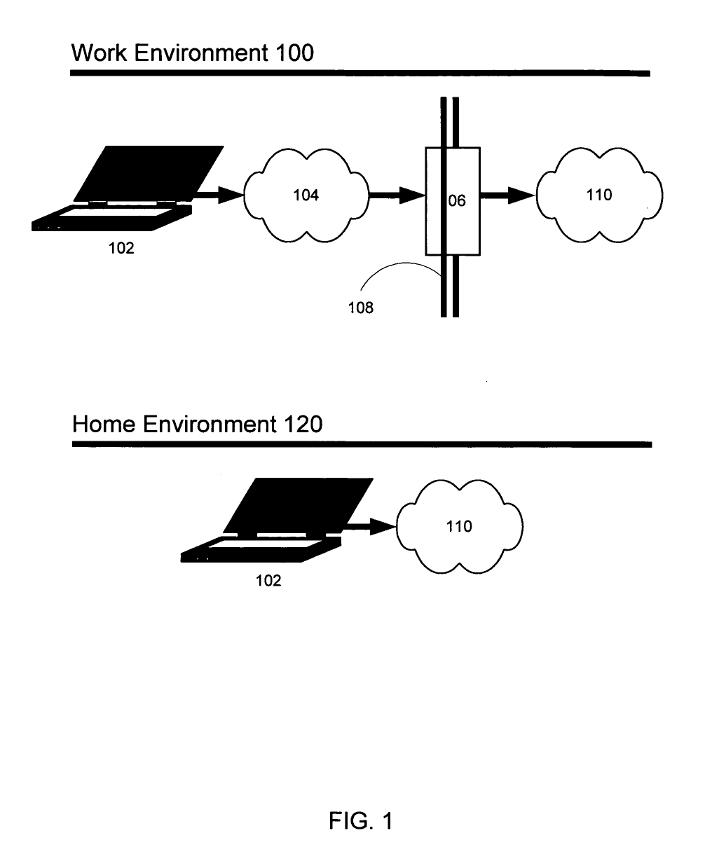

FIG. 1 illustrates one embodiment of two sample environments in which the present invention operates. In a work environment 100 the mobile computing device 102 connects to the local area network 104. The mobile computing device 102 must traverse a firewall 108 at work to access the Internet 110. The proxy server 106 is the only accessible method of traversing firewall 108 in work environment 100. Additionally, to utilize the proxy server 106 all applications residing on the mobile computing device 102 that communicate over the network must be configured with the correct settings associated with the proxy server 106. At another point in time the mobile computing device 102 is moved from the work environment 100 to a home environment 120. When the mobile computing device 102 connects up to the network at the home environment 120 it actually connects directly to the Internet 110. No proxy server or firewall exists in the home environment 120. In this scenario, all applications residing on mobile computing device 102 that communicate over the Internet 110 must be reconfigured with the correct settings associated with the direct connection to the Internet 110. The proxy server 106 settings that mobile computing device was configured with at the work environment 100 would no longer be functional. This reconfiguration would need to take place every time the mobile computing device 102 switched networks that had different configuration settings necessary for connection. In another embodiment the mobile computing device 102 would travel between two separate work environments that had different and unique proxy servers with different settings, requiring the same configuration. In yet another embodiment the mobile computing device 102 would travel between multiple home environments, multiple work environments, multiple school environments, as well as other environments, each environment having its own unique set of network settings to effectively connect to the Internet in each respective environment.

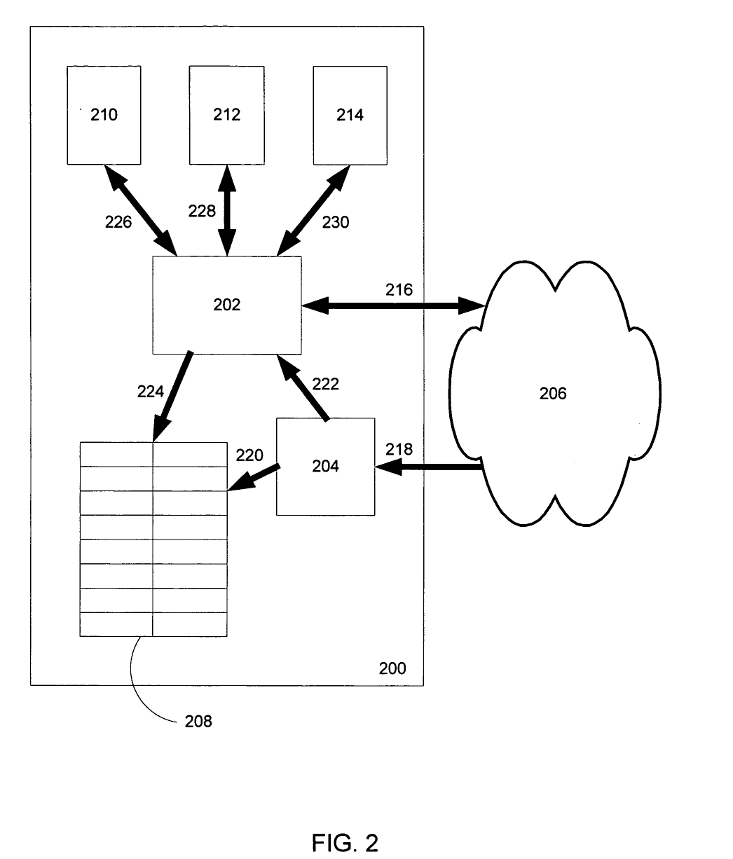

FIG. 2 illustrates one embodiment of the present invention operating on a mobile computing device. Mobile computing device 200 has multiple applications (210, 212, and 214) residing on it that utilize network communications. When mobile computing device 200 connects to local network 206 the dynamic host configuration protocol (DHCP) server on the network automatically provides information associated with the network including the Internet protocol (IP) address, subnet mask, default gateway, and domain name server (DNS) information. In one embodiment network service 202 is running in the background on the device to continuously monitor the network connection. When the mobile computing device 200 connects to local network 206, the network service 202 will become aware of the newly connected network by DHCP information provided by the local network 206 upon the connection 216. The DHCP information consists of enough unique information that a combination of one or more items of information provided will render a unique network identifier for the current network. In one embodiment the unique network identifier consists of the combination of the network's IP address and the network's subnet mask. In another embodiment the unique network identifier consists of a combination of one or more of the following items related to the current network: the IP address, the subnet mask, the default gateway, the DHCP server, the DNS server, and the DNS suffix, among others.

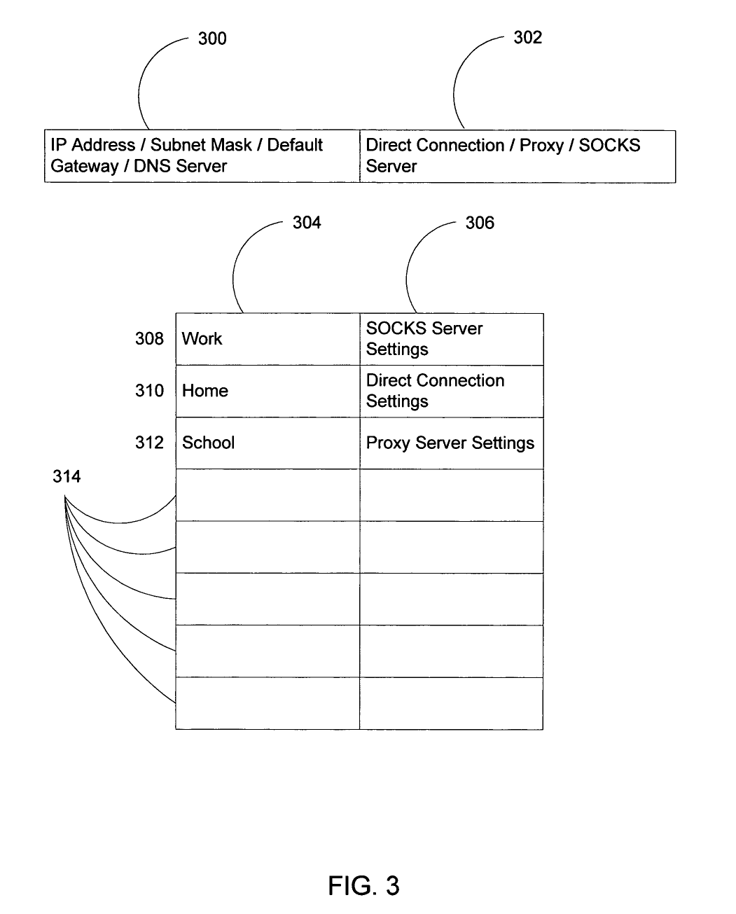

A list of known unique network identifiers is stored in database 208 in one embodiment of the present invention. Each unique network identifier in the database is coupled to information regarding the local network's 206 configuration. For example, one network might have a direct connection to the Internet and no special settings are needed to gain access. Another network that connects to the Internet through a proxy server would have configuration information regarding the settings necessary to connect to the proxy server. Thus, the database 208 lists all connection information necessary to properly obtain a connection to the network that is associated with the obtained unique network identifier. FIG. 3 gives a more detailed description of the database 208.

Additionally, the network service 202 that is monitoring the network connection between the device and the network will notice when an application (210, 212, or 214) attempts to make a connection to a remote device or server on the local network 206. This request (226, 228, or 230 respectively) is redirected 222 to a traffic routing component 204. The traffic routing component 204 also resides on mobile computing device 200. The traffic routing component 204 analyzes the traffic originating from the application during runtime and redirects 218 the traffic to the final destination on the local network 206. The traffic routing component 204 accomplishes this by utilizing information 220 associated with the connected network retrieved from the database 208 as well as information pulled directly from the application traffic itself 218. Information that the traffic routing component 204 uses includes the destination IP address embedded in each traffic packet and the protocol of each packet, among others.

FIG. 3 illustrates the database in one embodiment of the invention. The database stores at least two columns of items (304 and 306) associated with each known network. Those items make up an element in the database consisting of a unique network identifier 300 that is associated with each known network and a set of network configuration settings 302 necessary to effectively connect to the given network. The unique network identifier 300 associated with each known network can include, but is not limited to, one or more of the following items: the IP address, the subnet mask, the default gateway, the DHCP server, the DNS server, and the DNS suffix, among others. The network configuration settings 302 per network consist of the information dealing with network connections that could include proxy server settings, direct Internet connection settings, SOCKS server settings, among others. For example, database element 308 consists of a unique network identifier that is associated with a network at a work environment and the settings for effectively connecting to a SOCKS server located on that network. Database element 310 identifies a home environment network with settings associated with a direct connection to the Internet. Database element 312 identifies a school environment using settings associated with a connection to the Internet through a proxy server. The database stores as many elements 314 as there are known networks.

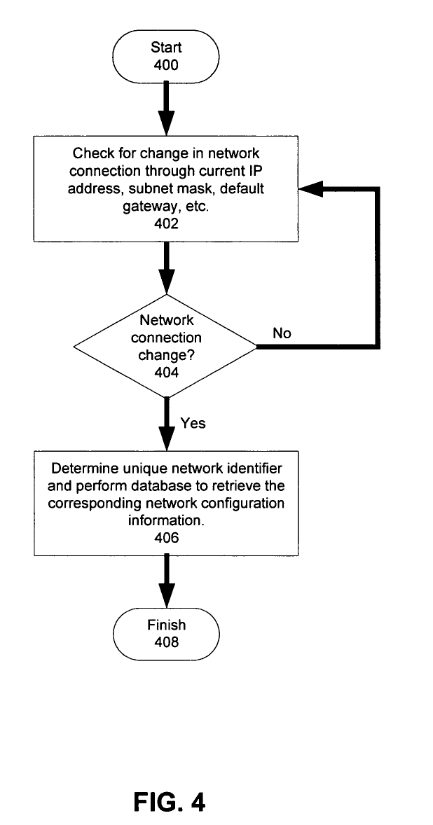

FIG. 4 illustrates a step-by-step process for detecting a unique network identifier on a network in one embodiment of the present invention. At the start 400 of the process the network service checks for a change in the network connection through polling information on the network including, but not limited to, the current IP address, the subnet mask, the default gateway, among other items of information (402). If there is no change from the previous check the network service returns and polls the network again. In one embodiment of the invention the network service continually monitors the network by constantly checking to see if the connection has been modified. In another embodiment of the invention the check is done in real-time for every data packet in the network traffic sent from the device to the connected network. If there is a network connection change found (404) then the network service determines the unique network identifier from the network and attempts to find a matching identifier in the database (406). Once the unique network identifier is found in the database the correct network configuration information are available for use to effectively send outbound traffic on the current network and the process is completed (408). In one embodiment of the invention the network service stores the network configuration information separately to be utilized by the traffic routing component when necessary. In another embodiment of the invention the network service can point any inquiries for network configuration information from the traffic routing component to the correct entry in the database itself. Otherwise, if the identifier is not found in the database the network service can default to a generic set of network configuration information in one embodiment of the invention. In another embodiment of the invention, if the currently connected network is not in the database the network service can prompt the user to enter specific network configuration information into the device to create a new entry in the database and establish a new, fully operational network connection. In another embodiment of the invention, a corporate or other network administrator can configure automatic updates of the configuration information database to take place when the client is connected to the corporate network.

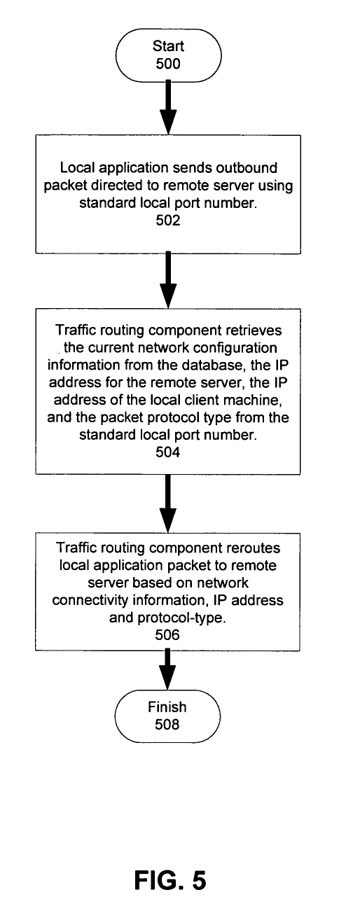

In one embodiment of the invention the network service and the traffic routing component emulate the functionality of a network interface card. The operating system sends all outbound network traffic originating from each application to this virtual device as if the virtual device was a standard network interface card. FIG. 5 illustrates a step-by-step process of a virtual network interface card implementation of one embodiment of the invention. At the start 500 of the process the application on the device sends an outbound packet directed to a remote server on the connected network using a standard local port number (502). The specific local port number distinguishes different network protocols. The network service listens to a specific predetermined port number for outbound traffic. When an outbound packet is identified the traffic routing component will then retrieve the current network configuration information from the database, the IP address of the local client machine, the IP address for the remote server, and the packet protocol type from the standard local port number (504). The traffic routing component then reroutes the application packet to the remote server on the network based on the network configuration information and the protocol-type (506) and the process is finished (508). The traffic routing component, in a sense, intercepts the packet by preventing the packet from traveling directly to the remote server and rerouting the packet with the updated addressing information. The invention is hidden from the application in this embodiment because no modifications are necessary to the application network settings. Applications think they are sending packets directly to the remote server IP address and port number through a real network interface card. If necessary, the virtual network interface card reformulates the packet to send it through a SOCKS server unbeknownst to the application. In this embodiment, the invention does internal bookkeeping to make sure that packets are returned to the proper application when they return.

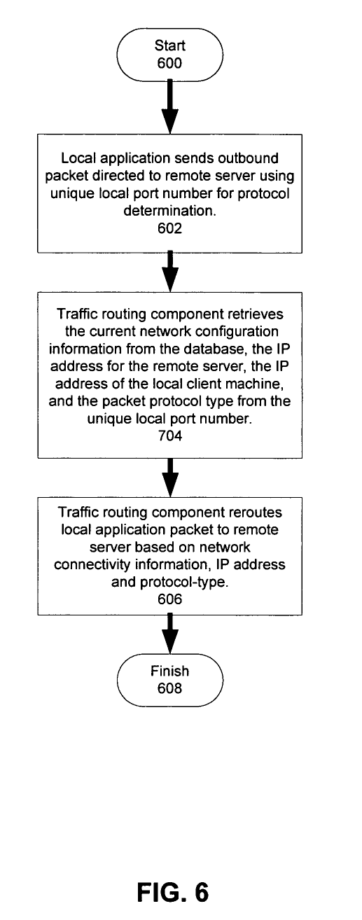

In another embodiment of the invention each network-enabled application residing on the user's computer, such as Internet Explorer, Microsoft Outlook, and AOL Instant Messenger, is configured to point to its own unique local network port. An application such as Internet Explorer that utilizes HTTP protocol would point to one unique local port, such as 5001. Whereas an application such as Microsoft Outlook that utilizes POP3 protocol would point to another unique local port, such as 5002. FIG. 6 illustrates a step-by-step process of a multiple unique local network port implementation of one embodiment of the invention. At the start 600 of the process the local application sends an outbound packet directed to a remote server using a unique local port number for the determination of the network protocol (602). The network service monitors the local port number for any outbound packets. When an outbound packet is sent to the unique local port number the traffic routing component will retrieve the current network configuration information from the database, the IP address for the remote server, the IP address of the local client machine, and the packet protocol type from the unique local port number (604). Finally, the traffic routing component reroutes the application packet to the remote server on the network based on the network configuration information, the IP address, and the protocol type (606) and the process is finished (608). In this embodiment every application, remote server IP address, and remote server port number each have their own unique local port number. The network service component specifically listens for all outbound traffic on each of those unique ports. The applications would be configured to send their information to the unique local port numbers instead of the standard port numbers for each network protocol.

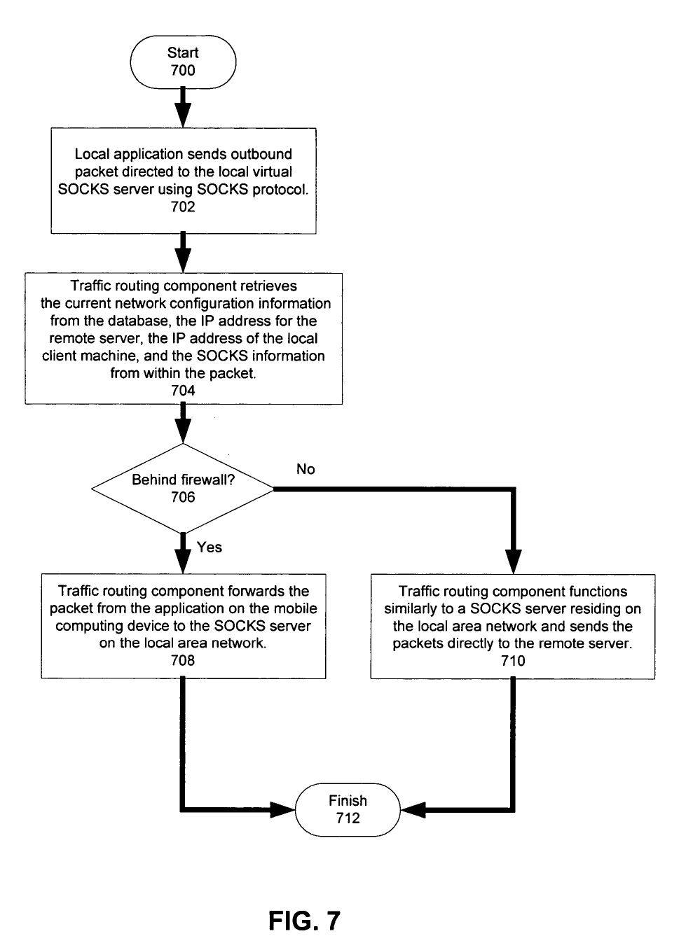

In another embodiment of the invention the network service and the traffic routing component emulate the functionality of a SOCKS server. In this embodiment the invention is implemented to look and function similarly to a SOCKS server running locally on the mobile computing device. The network service and the traffic routing component operate in the same fashion as in previous embodiments with the addition of having the interface of a SOCKS server for the benefit of the communications with the applications on the device. All applications are configured to connect directly to the virtual SOCKS server on the mobile computing device using the mobile computing device's local IP address and a specific port number (often port 1080 by convention). FIG. 7 illustrates a step-by-step process of a virtual SOCKS server implementation of one embodiment of the invention. At the start 700 of the process the application on the device sends an outbound packet directed to the local virtual SOCKS server using SOCKS protocol (702). Next, the traffic routing component retrieves the current network configuration information from the database, the IP address for the remote server, the IP address of the local client machine, and the SOCKS information from within the packet (704). Then the network service determines whether or not the mobile computing device is behind a firewall and notifies the traffic routing component (706). If a firewall is present, the traffic routing component will automatically forward the packets from the application on the mobile computing device to the SOCKS server on the local area network (708) using the retrieved network configuration information. In this manner, the application uses two cascaded SOCKS servers to access the remote server on the Internet. The application is unaware of the existence of the second SOCKS server on the local area network. Otherwise, if a firewall is not present the virtual SOCKS server functions similarly to a SOCKS server residing on the local area network and sends the packets directly to the remote server using the network configuration information the IP address for the remote server, the IP address of the local client machine, and the SOCKS information from within the packet (710) and the process is finished (712).

In the above embodiments the invention creates an extra layer of indirection for network traffic to pass through before leaving the device. The extra layer of indirection, similar to a local proxy located on the device, allows for one uniform and universal set of network configuration settings for each application residing on the device so no modifications are necessary as the device moves from network to network. Thus, a method for auto-configuring the network settings for each application residing on a mobile computing device when that device attaches to a given network is disclosed. Although the invention has been described particularly with reference to the figures, it may appear in any number of systems. It is further contemplated that many changes and modifications may be made by one of ordinary skill in the art without departing from the spirit and scope of the disclosed invention.

1. A method, comprising:
connecting a device to a network;
determining a unique identifier based on the network;
obtaining network configuration settings that are associated with the unique network identifier;
intercepting network traffic originating from an application located on the device; and
rerouting the intercepted network traffic to a final correct location using the obtained network configuration settings.

2. The method of claim 1 wherein the unique network identifier is comprised of one or more items from a group consisting of an Internet protocol address, a subnet mask, a domain name server address, a domain name server suffix, a default gateway, and a dynamic host configuration protocol.

3. The method of claim 1 wherein connecting a device to a network and determining a unique identifier based on the network further comprises:
monitoring the connection between the device and the network;
detecting a change in network connectivity; and
determining the unique network identifier after a change in network connectivity.

4. The method of claim 1 wherein obtaining network configuration settings that are associated with the unique network identifier further comprises:
storing a list of information relating to one or more networks including at least a unique network identifier for each network and an associated set of network configuration settings for each network; and
looking up the unique network identifier in the stored list and obtaining the network configuration settings associated with that unique network identifier in the stored list.

5. The method of claim 1 wherein intercepting network traffic originating from an application located on the device further comprises:
monitoring the network connection between the device and the network for outbound traffic from the device; and
preventing outbound traffic from exiting the device.

6. The method of claim 5 wherein intercepting network traffic originating from an application located on the device further comprises:
implementing a network service on the device;
emulating a network interface card with the network service; and
directing application network traffic to the emulated network interface card.

7. The method of claim 5 wherein intercepting network traffic originating from an application located on the device further comprises:
implementing a network service on the device;
assigning the network service a unique network port number for each network-enabled application; and
directing application network traffic to the unique network port number associated with the application.

8. The method of claim 5 wherein intercepting network traffic originating from an application located on the device further comprises:
implementing a network service on the device;
assigning the network service a unique network port number for each network protocol; and
directing application network traffic to the unique network port number associated with the applicable network protocol.

9. The method of claim 5 wherein intercepting network traffic originating from an application located on the device further comprises:
implementing a network service on the device;
emulating a SOCKS server with the network service; and
directing application network traffic to the emulated SOCKS server.

10. The method of claim 4 wherein rerouting the intercepted network traffic to a final correct location using the obtained network configuration settings further comprises:
determining the correct network protocol and final destination address by analyzing the network traffic originating from the application;
routing the traffic to the proper destination address by utilizing the determined network protocol, the final destination address, and the obtained network configuration settings.

11. A machine readable medium having embodied thereon instructions, which when executed by a machine, comprises:
connecting a device to a network;
determining a unique identifier based on the network;
obtaining network configuration settings that are associated with the unique network identifier;
intercepting network traffic originating from an application located on the device; and
rerouting the intercepted network traffic to a final correct location using the obtained network configuration settings.

12. The machine readable medium of claim 1 1 wherein connecting a device to a network and determining a unique identifier based on the network further comprises:
monitoring the connection between the device and the network;
detecting a change in network connectivity; and
determining the unique network identifier after a change in network connectivity.

13. The machine readable medium of claim 11 wherein obtaining network configuration settings that are associated with the unique network identifier further comprises:
storing a list of information relating to one or more networks including at least a unique network identifier for each network and an associated set of network configuration settings for each network; and
looking up the unique network identifier in the stored list and obtaining the network configuration settings associated with that unique network identifier in the stored list.

14. The machine readable medium of claim 11 wherein intercepting network traffic originating from an application located on the device further comprises:
monitoring the network connection between the device and the network for outbound traffic from the device; and
preventing outbound traffic from exiting the device.

15. The machine readable medium of claim 14 wherein rerouting the intercepted network traffic to a final correct location using the obtained network configuration settings further comprises:
determining the correct network protocol and final destination address by analyzing the network traffic originating from the application;
routing the traffic to the proper destination address by utilizing the determined network protocol, the final destination address, and the obtained network configuration settings.

16. A system, comprising:
a bus;
a processor coupled to the bus;
a network interface coupled to the bus; and
memory coupled to the processor, the memory adapted for storing instructions, which upon execution by the processor connect a device to a network, determine a unique identifier based on the network, obtain network configuration settings that are associated with the unique network identifier, intercept network traffic originating from an application located on the device, and reroute the intercepted network traffic to a final correct location using the obtained network configuration settings.

17. The system of claim 16 wherein the unique network identifier is comprised of one or more items from a group consisting of an Internet protocol address, a subnet mask, a domain name server address, a domain name server suffix, a default gateway, and a dynamic host configuration protocol.

18. The system of claim 16 wherein connecting a device to a network and determining a unique identifier based on the network further comprises:
monitoring the connection between the device and the network;
detecting a change in network connectivity; and
determining the unique network identifier after a change in network connectivity.

19. The system of claim 16 wherein obtaining network configuration settings that are associated with the unique network identifier further comprises:
storing a list of information relating to one or more networks including at least a unique network identifier for each network and an associated set of network configuration settings for each network; and
looking up the unique network identifier in the stored list and obtaining the network configuration settings associated with that unique network identifier in the stored list.

20. The system of claim 16 wherein intercepting network traffic originating from an application located on the device further comprises:
monitoring the network connection between the device and the network for outbound traffic from the device; and
preventing outbound traffic from exiting the device.

21. The system of claim 20 wherein intercepting network traffic originating from an application located on the device further comprises:
implementing a network service on the device;
emulating a network interface card with the network service; and
directing application network traffic to the emulated network interface card.

22. The system of claim 20 wherein intercepting network traffic originating from an application located on the device further comprises:
implementing a network service on the device;
assigning the network service a unique network port number for each network-enabled application; and
directing application network traffic to the unique network port number associated with the application.

23. The system of claim 20 wherein intercepting network traffic originating from an application located on the device further comprises:
implementing a network service on the device;
assigning the network service a unique network port number for each network protocol; and
directing application network traffic to the unique network port number associated with the applicable network protocol.

24. The system of claim 20 wherein intercepting network traffic originating from an application located on the device further comprises:
implementing a network service on the device;
emulating a SOCKS server with the network service; and
directing application network traffic to the emulated SOCKS server.

25. The system of claim 19 wherein rerouting the intercepted network traffic to a final correct location using the obtained network configuration settings further comprises:
determining the correct network protocol and final destination address by analyzing the network traffic originating from the application;
routing the traffic to the proper destination address by utilizing the determined network protocol, the final destination address, and the obtained network configuration settings.
